(19) United States
(12) Patent Application Publication
(10) Pub. No.: US 2007/0104861 A1
(43) Pub. Date: May 10, 2007

(54) White light LED production method

(76) Inventor: Hsing Chen, Jubei City (TW)

Correspondence Address: TROXELL LAW OFFICE;SUITE 1404, 5205 LEESBURG PIKE, FALLS CHURCH, VA, 22041, US

(21) Appl. No.: 11/269,734

(22) Filed: Nov. 9, 2005

(51) Int. Cl. B05D 5/12

(52) U.S. Cl. 427/66

(57) ABSTRACT

The traditional production method of white light LED is adding YAG phospher on blue light chips which causes two-wavelength white light that is only suitable for indication usage. Moreover, the difficulty in controlling adequate amount of phosphor powder leads to inaccurate color of light. Another production method for three wavelength white light by UV ehip arousing R.G.B.-mixed phosphor powder is degenerated in its life and quality due to lack of high-efficiency UV LED chips and UV-typed encapsulating resin. The production method of white light LED of the present invention consists of packaging substrate, purple light LED chip and R.G.B.-mixed phosphor powder. With purple light produced by purple light LED chips to arouse phosphor powder on the surface, the three-wavelength (tri-color) white light formed by R.G.B. lights takes shape. The present invention is the best choice in producing high brightness and three-wavelength (tri-color) white light LED.

### BACKGROUND OF THE INVENTION

Currently, there are two methods of producing single white light LED: adding yellow phosphor powder (YAG) onto the blue light chip, whose main producer is Japan Nichia (please refer to Taiwan patent publication number 383508) and producing white light by adding the R.G.B.-mixed phosphor powder on the Ultraviolet (UV) light chip, which is invented by the present inventor (please refer to Taiwan patent publication number 385063).

The disadvantage of the first method by adding yellow phosphor powder on the blue light chip is that the wavelength of the emitted white light is two-wavelength with blue light and yellow light only. Therefore, instead of achieving truly standard illumination purpose or acting as the back-lighted illumination for LCD, the white light produced in this way applies to indication only. The other disadvantage is that the difficulty in controlling accurate yellow phosphor powder causes the color of the light partial to become blue or yellow.

The second method that produces three-wavelength (tri-color) white light through the arousal of the UV light to the R.G.B.-mixed phosphor powder should be an ideal way. However, the lack of high efficiency UV light LED chips in the present makes it hard to achieve the efficacy provided by high efficiency UV light LED chip. So far as Japan Nichia is concerned, the present UV light LED whose wavelength is 371 nm produces the power of 2˜3 mw and for Toyoda Gosei, the wavelength of 380 nm produces the power of 2˜3 mw.

Still one disadvantage is the lack of UV light-typed transparent encapsulating resin since most organic resin absorbs UV light that deteriorates itself, which in turn degenerates the life and the quality of LED.

The inventor of the present invention has worked in the development of white light LED for years and obtained several international white light LED patent certifications. Focusing on the disadvantages of the white light LED production mentioned above, the inventor of the present invention proposed a new method of producing white light LED easily by arousing the phosphor powder to produce three-wavelength (tri-color) white light LED with the UV light (with a wavelength of 390˜410 nm).

### SUMMARY OF THE INVENTION

Different from the traditional production that adds yellow phosphor powder (YAG) on the blue light chip or arouses the R.G.B-mixed phosphor powder to produce three-wavelength (tri-color) of white light by the UV light, the production of the white light LED for the present invention is through arousing the phosphor powder to produce white light with the UV light whose wavelength falls between 390˜410 nm.

The reason of adopting UV light in the present invention is that the Cree Corporation in U.S has developed the LED chip with a wavelength between 390˜395 nm and emitting power over 20 mw that transcends the present blue light or UV light in emitting efficiency and power. Another reason is that the phosphor powder (R.G.B) that can be aroused by UV light (whose wavelength ranges between 390˜410 nm) has been developed, in which

Red is 6MgO.AS2O5:Mn or 3.5 MgO.0.5Mg F2.GeO2:Mn

Green is Ba(2−x)Srx Sio4:Eu(x≦1)

Blue is (Sr.Ca.BaMg)10(PO4)6Cl2:Eu

By mixing up an adequate percentage of R.G.B. phosphor powder, the white light or other light can be produced. Below is the description of the illustrations for the present invention:

### BRIEF DESCRIPTION OF THE DRAWINGS

FIG. 1 is the structural illustration that shows the lead frame packaging structure of the traditional white light LED.

FIG. 2 is the structural illustration that shows the lead frame packaging structure of the white light LED in the present invention.

FIG. 3 is another structural illustration that shows the lead frame manufacturing the white light LED in the present invention.

FIG. 4 is the structural illustration that shows the molding manufacturing of the white light LED in the present invention.

FIG. 5 is the spectrum illustration of the white light LED in the present invention.

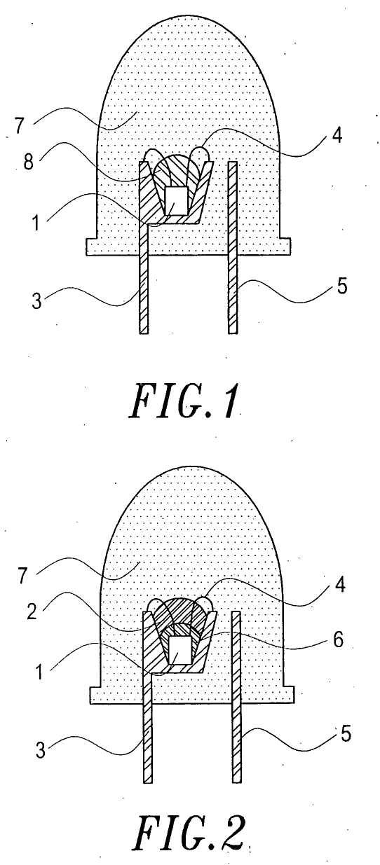

### DETAILED DESCRIPTION OF THE INVENTION

Please refer to FIG. 2. First of all, mix and deploy adequate percentages of the R.G.B.-mixed phosphor powder 2 that is sufficient to emit white light under the arousal of UV light. To achieve different demands of different customers who require a color temperature of 3000-8000K, it can be done by adjusting the percentage of the R.G.B.-mixed phosphor powder 2.

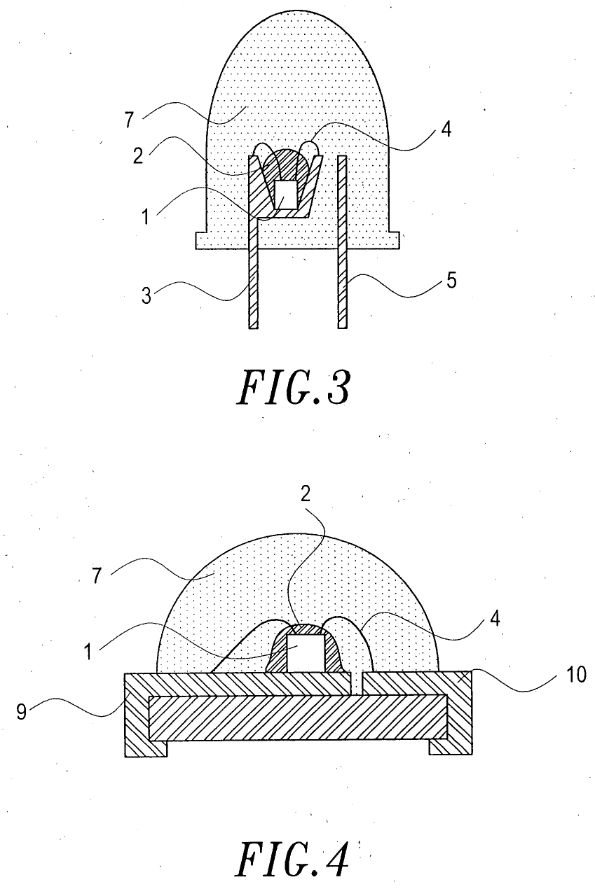

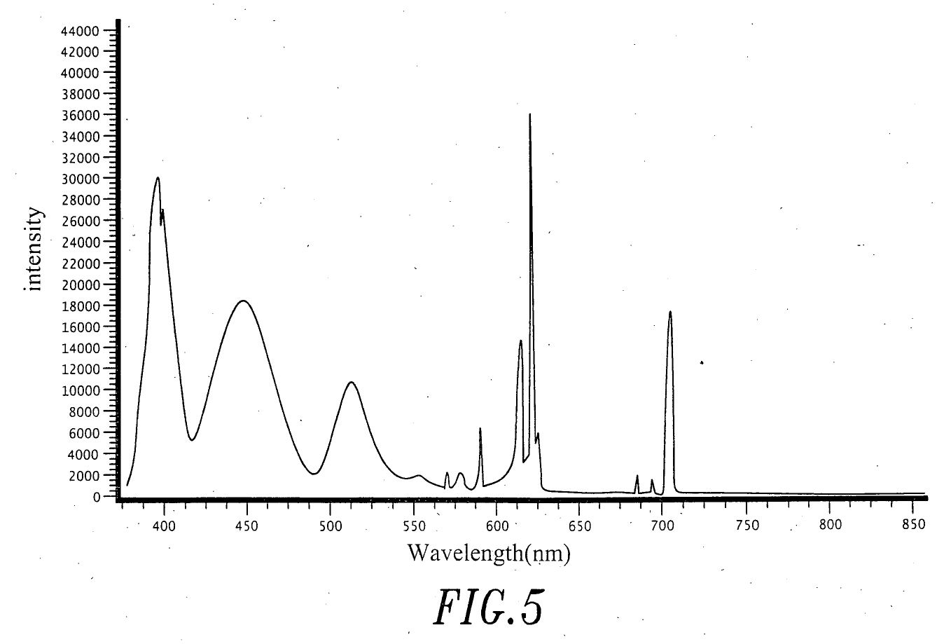

Fix the UV light LED chip 1 on the packaging lead frame 3 or the packaging substrate 9 with the wire lead 4 connected respectively to the LED chip 1, the lead frame electrode 5 (or the substrate electrode 10) and the packaging lead frame 3 (or packaging substrate 9). Then, with the adequately mixed R.G.B.-mixed phosphor powder 2 painted directly or indirectly (as shown in FIGS. 3 and 4) on the surface of the UV light LED chip 1 for it to arouse the R.G.B.-mixed phosphor powder 2 on the surface to produce the white light formed by the three waves(tri-color) of R.G.B, as shown in the spectrum illustration in FIG. 5.

Composed of a packing substrate 9 and a lead frame 3, a purple light LED chip 1 is capable of emitting a light with a wavelength between 390 and 410 nm and phosphor powders for generating red, blue and green lights. The method comprising the steps of:

a) fixing the purple light LED chip 1 on the packing substrate 9 or the lead frame 3 and connecting the purple light LED to substrate electrodes 5;

b) mixing the phosphor powders with a transparent glue, the phosphor powder for generating the red light are 6MgO.AS2O5:Mn or 3.5 MgO.0.5Mg F2.GeO2:Mn, the phosphor powder for generating the green light are Ba(2−x)Srx Sio4:Eu(x□1) and the phosphor for generating the blue light blue are (Sr.Ca.BaMg)10(PO4)6Cl2:Eu; and

c) coating or gluing the mixed phosphor powders and glue 6 onto the purple light LED chip 1,

wherein the phosphor powders are excited by the light emitted by the purple light LED so that a white light is outputted by mixing the red, green and blue lights through the phosphor powders.

The R.G.B.-mixed phosphor powder 2 of the present invention consists of: 6MgO.AS2O5:Mn or 3.5 MgO.0.5Mg F2.GeO2:Mn for red; Ba(2−x)Srx Sio4:Eu(x≦1) for green and (Sr.Ca.BaMg)10(PO4)6Cl2:Eu for blue.

Besides the foregoing phosphor powder, there are other phosphor powder available for the present invention, including other phosphor powder that can be aroused by the UV light whose wavelength lies between 390˜410 nm.

Traditional phosphor powder aims at the illuminant with a wavelength of 254 nm or 365 nm. White light aroused by UV light is rarely seen. This is because high efficiency UV light LED chip 1 is not developed until the past year. Arousing the phosphor powder to produce white light by the high efficiency UV light LED chip 1 is the origination of the inventor for the present invention. Even if it might not be the mainstream in the future, this is still the best choice in producing high brightness and three wavelengths (tri-color) white light LED.

What is claimed is:

1. A production method for white light LED, composed of a packing substrate and a lead frame, a purple light LED chip capable of emitting a light with a wavelength of between 390 and 410 nm and phosphor powders for generating red, blue and green lights, the method comprising the steps of:
a) fixing the purple light LED chip on the packing substrate or lead frame and connecting the purple light LED to substrate electrodes;
b) mixing the phosphor powders with a transparent glue, the phosphor powder for generating the red light being 6MgO.AS₂O₅:Mn or 3.5 MgO.0.5Mg F₂.GeO₂:Mn, the phosphor powder for generating the green light being Ba(2−x)Sr, Sio4:Eu(x≦1) and the phosphor for generating the blue light blue being (Sr.Ca.BaMg)₁₀(PO₄)₆Cl₂:Eu; and
c) coating or gluing the mixed phosphor powders and glue onto the purple light LED chip,
wherein the phosphor powders are excited by the light emitted by the purple light LED so that a white light is outputted by mixing the red, green and blue lights through the phosphor powders.

2. The production method for white light LED of claim 1, wherein said packaging substrate can be PCB circuit boards, ceramic substrate, silicon substrate or metal substrate.
